(19) United States
(12) Patent Application Publication
(10) Pub. No.: US 2023/0308916 A1
(43) Pub. Date: Sep. 28, 2023

(54) SYSTEM AND METHOD FOR REFERENCE SIGNALING DESIGN AND CONFIGURATION

(71) Applicant: ZTE CORPORATION, Shenzhen (CN)

(72) Inventors: Shujuan ZHANG, Shenzhen (CN); Chuangxin JIANG, Shenzhen (CN); Bo GAO, Shenzhen (CN); Zhaohua LU, Shenzhen (CN); Hao WU, Shenzhen (CN); Ke YAO, Shenzhen (CN)

(21) Appl. No.: 18/204,111

(22) Filed: May 31, 2023

Related U.S. Application Data
(63) Continuation of application No. PCT/CN2021/071929, filed on Jan. 14, 2021.

(51) Int. Cl. H04W 24/08; H04W 76/19

(52) U.S. Cl. CPC H04W 24/08; H04W 76/19

(57) ABSTRACT

A system and method for reference signaling design and configuration are disclosed herein. The method includes determining a serving cell set that includes one or more serving cells. Each of the one or more serving cells is associated with a feature. The method includes sending a media access control element that includes a first bitmap field with S bits, where each of the S bits that corresponds to one of the serving cells, is associated with a respective relative serving cell index in the serving cell set, and indicates whether beam failure is detected for the serving cell.

### CROSS-REFERENCE TO RELATED APPLICATION

This application claims the benefit of priority under 35 U.S.C. § 120 as a continuation of International Patent Application No. PCT/CN2021/071929, filed on Jan. 14, 2021, the disclosure of which is incorporated herein by reference in its entirety.

### TECHNICAL FIELD

The disclosure relates generally to wireless communications and, more particularly, to systems and methods for reference signaling design and configuration.

### BACKGROUND

Wireless communication service covers more and more application scenarios, with the increasing degree of social digitization. Among them, enhanced mobile broadband, ultra-reliable and low latency communication and massive machine type of communication have become three major scenarios supported by fifth generation (5G) systems. However, conventional systems may not effectively recover from beam failure states or conditions in sufficiently broad use cases. Thus, a technological solution for reference signaling design and configuration is desired.

### SUMMARY

The example implementations disclosed herein are directed to solving the issues relating to one or more of the problems presented in the prior art, as well as providing additional features that will become readily apparent by reference to the following detailed description when taken in conjunction with the accompany drawings. In accordance with various implementations, example systems, methods, devices and computer program products are disclosed herein. It is understood, however, that these implementations are presented by way of example and are not limiting, and it will be apparent to those of ordinary skill in the art who read the present disclosure that various modifications to the disclosed implementations can be made while remaining within the scope of this disclosure.

In one implementation, a method performed by a wireless communication device includes determining a serving cell set that includes one or more serving cells, wherein each of the one or more serving cells is associated with a feature, and sending a media access control element (MAC CE) that includes a first bitmap field with S bits, where each of the S bits that corresponds to one of the serving cells, is associated with a respective relative serving cell index in the serving cell set, and indicates whether beam failure is detected for the serving cell.

In another implementation, a method performed by a wireless communication device includes sending a MAC CE that includes a first bitmap field with S bits and a second bitmap field with Q bits, where each of the S bits corresponds to one serving cell and indicates whether beam failure is detected for one serving cell, and each of the Q bits corresponds to a value of 1 in the first bitmap field.

In another implementation, a method performed by a wireless communication device includes sending a MAC control element (MAC-CE) that includes a first field with S pairs of bits, wherein each of the S pairs corresponds to one of a plurality of serving cells.

In another implementation, a method performed by a wireless communication device includes determining whether a condition is satisfied, and sending BFR information in a BFR MAC CE format based on the determination.

In another implementation, a method performed by a wireless communication device includes determining a parameter index for each of one or more information elements of a channel, where an information element includes one of a beam state, a reference signal (RS) set, and power information.

In another implementation, a method performed by a wireless communication device includes detecting beam failure based on a first beam failure detecting RS set, and if beam failure is detected based on the first beam failure detecting RS set, reporting up to Y RS indices for the first beam failure detecting RS set wherein Y is larger than 1.

The above and other aspects and their implementations are described in greater detail in the drawings, the descriptions, and the claims.

### BRIEF DESCRIPTION OF THE DRAWINGS

Various example implementations of the present solution are described in detail below with reference to the following figures or drawings. The drawings are provided for purposes of illustration only and merely depict example implementations of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques and other aspects disclosed herein may be implemented, in accordance with an implementation of the present disclosure.

FIG. 2 illustrates block diagrams of an example base station and a user equipment device, in accordance with some implementations of the present disclosure.

FIG. 3 illustrates a first example medium access control (MAC) control element (MAC-CE), in accordance with present implementations.

FIG. 4 illustrates a first example plurality of serving cells, in accordance with present implementations.

FIG. 5 illustrates an example serving cell configuration, in accordance with present implementations.

FIG. 6 illustrates a second example MAC-CE, in accordance with present implementations.

FIG. 7 illustrates a second example plurality of serving cells, in accordance with present implementations.

FIG. 8 illustrates a third example MAC-CE, in accordance with present implementations.

FIG. 9 illustrates a fourth example MAC-CE, in accordance with present implementations.

FIG. 10 illustrates a fifth example MAC-CE, in accordance with present implementations.

FIG. 11 illustrates a sixth example MAC-CE, in accordance with present implementations.

FIG. 12 illustrates a seventh example MAC-CE, in accordance with present implementations.

FIG. 13 illustrates an eighth example MAC-CE, in accordance with present implementations.

FIG. 14 illustrates a ninth example MAC-CE, in accordance with present implementations.

FIG. 15 illustrates a tenth example MAC-CE, in accordance with present implementations.

FIG. 16 illustrates an eleventh example MAC-CE, in accordance with present implementations.

FIG. 17 illustrates a twelfth example MAC-CE, in accordance with present implementations.

FIG. 18 illustrates a first example core resource set (CORESET) configuration, in accordance with present implementations.

FIG. 19 illustrates a second example CORESET configuration, in accordance with present implementations.

FIG. 20 illustrates a first example user equipment (UE) configuration, in accordance with present implementations.

FIG. 21 illustrates a second example UE configuration, in accordance with present implementations.

FIG. 22 illustrates a thirteenth example MAC-CE, in accordance with present implementations.

FIG. 23 illustrates a third example UE configuration, in accordance with present implementations.

FIG. 24 illustrates a fourth example UE configuration, in accordance with present implementations.

FIG. 25 illustrates a first example method for reference signaling design and configuration, in accordance with present implementations.

FIG. 26 illustrates a second example method for reference signaling design and configuration, in accordance with present implementations.

### DETAILED DESCRIPTION OF EXAMPLE IMPLEMENTATIONS

Various example implementations of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example implementations and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

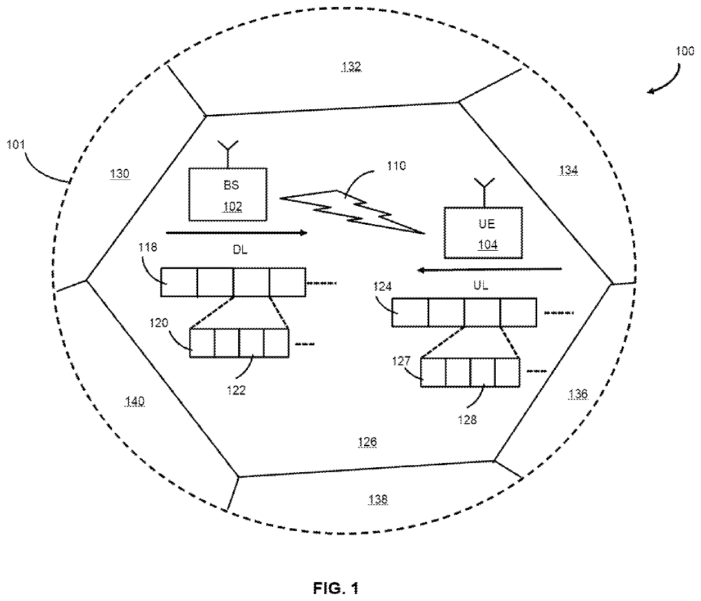

FIG. 1 illustrates an example wireless communication network, and/or system, 100 in which techniques disclosed herein may be implemented, in accordance with an implementation of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”) and a user equipment device 104 (hereinafter “UE 104”) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various implementations of the present solution.

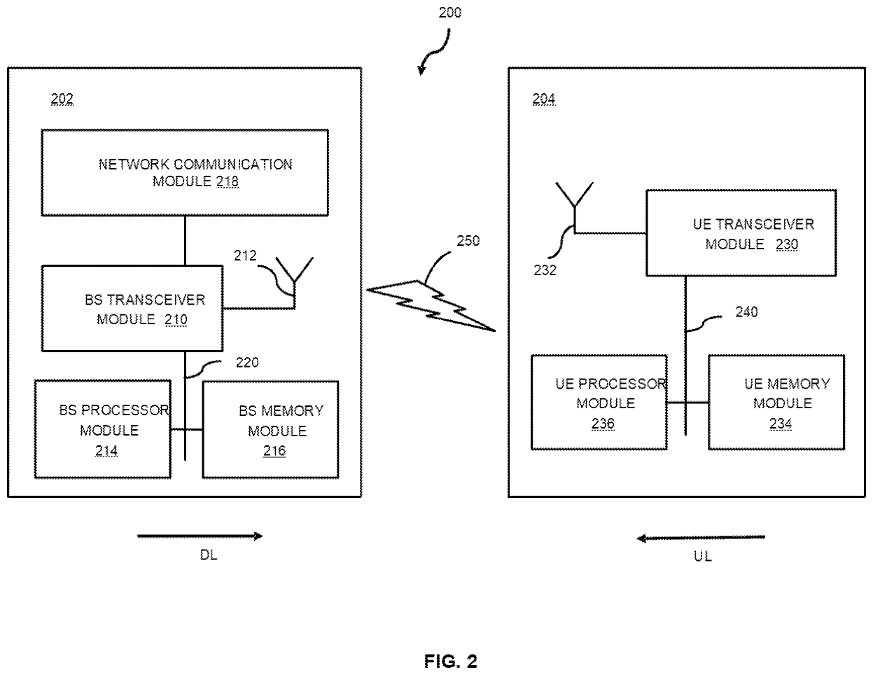

FIG. 2 illustrates a block diagram of an example wireless communication system 200 for transmitting and receiving wireless communication signals, e.g., OFDM/OFDMA signals, in accordance with some implementations of the present solution. The system 200 may include components and elements configured to support known or conventional operating features that need not be described in detail herein. In one illustrative implementation, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the implementations disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some implementations, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some implementations, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 can be coordinated in time such that the uplink receiver circuitry is coupled to the uplink antenna 232 for reception of transmissions over the wireless transmission link 250 at the same time that the downlink transmitter is coupled to the downlink antenna 212. In some implementations, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative implementations, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various implementations, the BS 202 may be an evolved node B (eNB), a serving eNB, a target eNB, a femto station, or a pico station, for example. In some implementations, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the implementations disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some implementations, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

In some implementations, New Radio (NR) adopts a beam failure recovery (BFR) process to recover links quickly. In some implementations, the NR also is configured to save power at a user equipment (UE) for the reporting that is event driven. In some implementations, links between UE and a base station gNodeB (gNB) can be recovered quickly when the link fails. In some implementations, the UE detects whether all links fail. Further, in some implementations, the UE will report beam failure information to the gNB once the UE detects beam failure occurrence based on a beam failure resource set. In this case, however, the current BFR is for one serving cell. Thus, in some implementations, the UE will initiate BFR only when all links of one serving cell fail. In some implementations, when one serving cell includes multiple TRPs, the UE only initiate BFR when all TRPs fail. Further, in some implementations, the gNB cannot timely recover one TRP. Thus, it is advantageous to recover individual or subsets of links between UE and TRP quickly. It is also advantageous to save overhead for reporting beam failure information.

In some implementations, the UE reports beam failure information using a Medium Access Control Control Element (MAC-CE) when the UE detects beam failure for at least one serving cell. In some implementations, the MAC-CE includes a bitmap field with S bits. In some implementations, the bitmap field indicates the serving cell index for which beam failure is detected. In some implementations, the i^{th} bit of the S bits corresponds to an i^{th} serving cell with a feature, i=1, 2, . . . S. Thus, in some implementations, the i^{th} bit of the S bits corresponds to a serving cell with index i, which is an relative index among a serving cell set. In some implementations, the serving cell set includes all serving cells with the feature. In some implementations, the S is smaller than or equals the number of serving cells configured for the UE in a serving cell group. In some implementations, the serving cell group is at least one of a Master serving cell group (MCG), or a Secondary serving cell group (SCG). In some implementations, the S is determined according to the number of serving cells with the feature.

In some implementations, the S can also be determined according to the highest serving cell relative index with beam failure occurrence in the serving cell set. In some implementations, the serving cell with the feature includes a serving cell which is configured with a BFR parameter. In this implementation, the BFR parameter includes at least one of a PRACH-BFR parameter, an SR-BFR, a candidate reference signal resource set q₁, a beam Failure Recovery Timer, a Threshold to determine whether a reference signal resource in set q₁ can be selected as a new resource when beam failure is detected, a Beam Failure Detection Timer, and a beam Failure Instance Max Count. In this implementation, the serving cell that is configured with a BFR parameter refers to at least one BWP of the serving cell that is configured with the BFR parameter. In some implementations, the serving cell with the feature includes a serving cell for which the UE needs to detect beam failure. In some implementations, the serving cell with the feature includes a serving cell in a serving cell set that is configured by the gNB or is determined by a predefined rule. In some implementations, the serving cell with the feature includes a serving cell including at least one Control resource set (CORESET). In some implementations, the serving cell with the feature includes a serving cell including at least one CORESET associated with a dedicated search space. In some implementations, the serving cell with the feature includes a serving cell associated with a beam failure index. In some implementations, the serving cell with the feature includes a serving cell with the lowest serving cell index in a serving cell list. In some implementations, the serving cell with the feature includes a serving cell with a lowest serving cell index in a serving cell list and with at least one feature discussed above. In some implementations, one MAC-CE that activates TCI states for PDSCH or CORESET applies for all serving cells in the serving cell list. For example, the MAC-CE can simultaneously activate a TCI state set for each serving cell in the serving cell list. For example, the TCI state set include at least one of: TCI state 1, TCI state 8, TCI state 9, or TCI state 20.

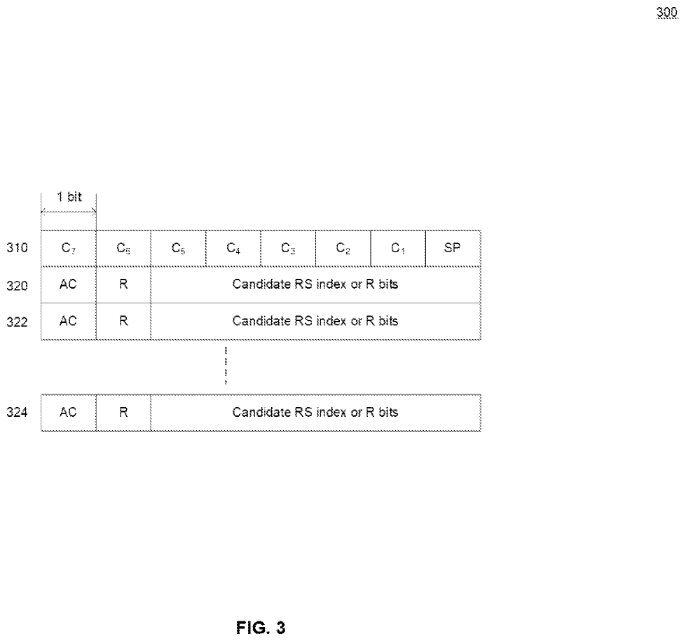

FIG. 3 illustrates a first example medium access control (MAC) control element (MAC-CE), in accordance with present implementations. As illustrated by way of example in FIG. 3, a first example MAC-CE 300 includes a serving cell set 310, a first AC field 320, a second AC field 322, and a third AC field 324.

In some implementations, the UE is configured with 32 serving cells in a serving cell group, but the UE is configured with only 8 serving cells with BFR parameter, so the number of the serving cell with the feature is 8. The serving cell set corresponding to the Cᵢ in FIG. 3 only includes the 8 serving cells with the BFR parameter. In some implementations, the serving cell group is at least one of an MCF and an SCG. In some implementations, the Cᵢ in FIG. 3 corresponds to the i^{th} serving cell with the feature. In some implementations, the SP in the MAC-CE corresponds to a special serving cell. For example, the SP can correspond to a primary serving cell in MCG, or a primary secondary serving cell in SCG. In some implementations, if the bit of Cᵢ is set to 1, it indicates that beam failure is detected for the i^{th} serving cell with the feature. In some implementations, that bit set 1 also indicates that the octet containing the AC field is present in the BFR MAC-CE. In some implementations, if the bit of Cᵢ is set to 0, it indicates that beam failure is not detected and the octet containing the AC field is not present for the i^{th} serving cell with the feature i=1, 2, . . . S. In some implementations, the AC field indicates the presence of the Candidate RS ID field in this octet. In some implementations, if at least one of candidate reference resource in candidate resource set q₁ with quality above a threshold is available, the AC field is set to 1, otherwise, the AC field is set to 0. In some implementations, if the AC field set to 1, the Candidate RS ID field is present. Alternatively, in some implementations, if the AC field set to 0, R bits are present instead. In some implementations, the candidate RS index is the selected RS index with quality higher than the threshold, and is in the predefined candidate reference signal resource set q₁ corresponding to a serving cell.

In some implementations, if the highest serving cell relative index in the serving cell set for which beam failure is detected is less than 8, the number of bits of the bitmap field for serving cell indication is 8, otherwise the number of bits in the bitmap field for serving cell indication is 32. In some implementations, the serving cell relative index is an index among serving cells with the feature, i.e., the serving cell relative index is an relative index in the serving cell set.

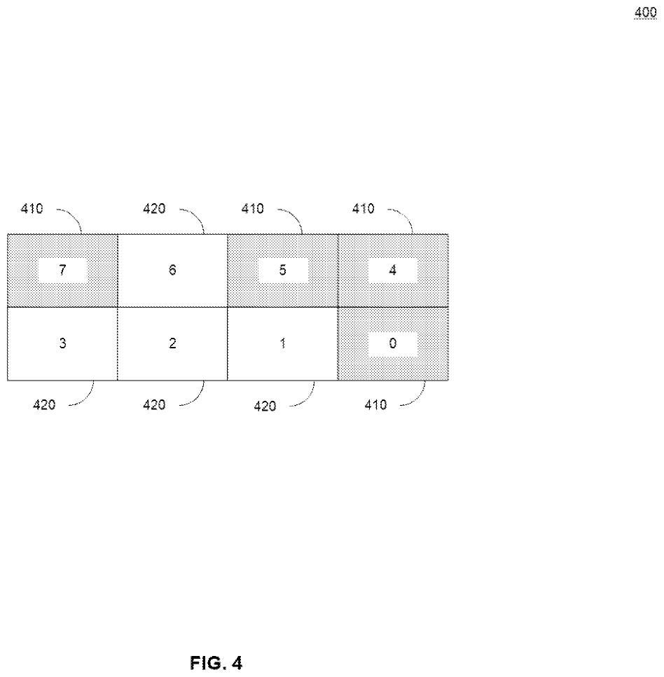

FIG. 4 illustrates a first example plurality of serving cells, in accordance with present implementations. As illustrated by way of example in FIG. 4, a first example plurality of serving cells 400 includes a first plurality of serving cells 410 with a feature, and a second plurality of serving cells 420 without the feature.

In some implementations, the UE is configured with 8 serving cells, with four serving cells having a feature. In some implementations, the serving cell set including serving cells with the feature includes serving cell 0, serving cell 4, serving cell 5, and serving cell 7. In some implementations, the SP in the MAC-CE of FIG. 3 corresponds to serving cell 0, and C₁, C₂, and C₃ respectively correspond to serving cell 4, serving cell 5 and serving cell 7. In some implementations, serving cell 0 is a primary serving cell. In some implementations, the serving cell relative index in the serving cell set starts from 0, where i=0, 1 . . . S−1, and an SP bit corresponds to a serving cell with relative index0. Alternatively, in some implementations, the Special cell serving cell always is with the feature. In some implementations, the serving cell set is not required to include the SPCell, i.e., the S bits corresponding to the serving cell set includes Cᵢ and SP bit in FIG. 3. Thus, In some implementations, the Gin the MAC-CE corresponds to at least one serving cell with relative index i starting from 1, i.e., i=1, . . . , S. In some implementations, S is the number of serving cells with the feature, i.e., the S bits corresponding to the serving cell set doesn't includes SP bit in FIG. 3.

In some implementations, the Cᵢ field corresponding to a serving cell index i and the serving cell index is a relative index among a serving cell set including serving cells with the feature. In some implementations, the field is not an absolute index configured by gNB and an index in a serving cell group (for example MCG or SCG). In some implementations, the serving cell set includes all serving cells with the feature. In some implementations, the serving cell index in the serving cell set is got in an ascending order of the absolute serving cell index. In some implementations, the number of bits in the bitmap of serving cell indication in BFR MAC-CE in FIG. 3 is determined according to the number of serving cells with the feature. In some implementations, especially when a list of serving cells share the same beam direction, beam failure is monitoring for only one of the serving cell list, the overhead of beam failure reporting can be reduced effectively.

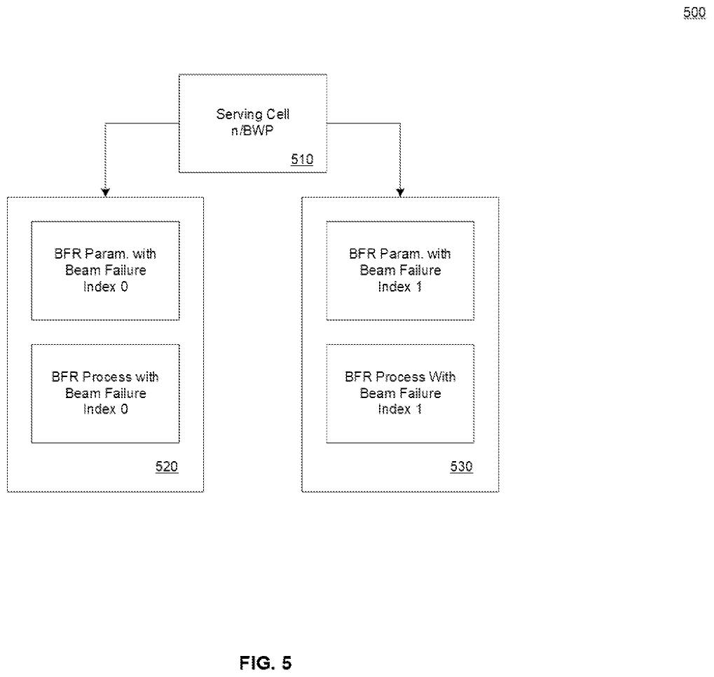

FIG. 5 illustrates an example serving cell configuration, in accordance with present implementations. As illustrated by way of example in FIG. 5, an example serving cell configuration 500 includes a serving cell 510, a first BFR parameter set 520, and a second BFR parameter set 530.

In some implementations, the serving cell with the feature includes the serving cell associated with a beam failure index (i.e., a parameter index). In some implementations, the beam failure index includes at least one of an index of a CORESET pool, an index of a PUCCH resource set, an index of a set of channel, an index of beam failure detecting reference signal resource set, an index of candidate reference signal resource set, an index associated with one or more beam failure parameters, and a physical cell index (PCI), an order index of a candidate RS index for a serving cell or for a BWP, or an index of a BFR process for a serving cell or for a BWP. In some implementations, the UE is configured with more than one beam failure index for a serving cell. In some implementations, each beam failure index is associated with a BFR parameter and a BFR process independently. In some implementations, one BFR MAC-CE includes beam failure information for one beam failure index. In some implementations, beam failure information associated with different beam failure indices is reported in different BFR MAC-CE.

In some implementations, a serving cell n (or a BWP b) is configured with two BFR parameter sets associated with beam failure index 0 and beam failure index 1 respectively as shown in FIG. 5. In some implementations, the two BFR parameter set includes some same type. For example, a serving cell (or a BWP) is configured with two beam failure detecting reference signal resource sets. In some implementations, each of the two beam failure detecting reference signal resource sets is associated with a beam failure index respectively. In some implementations, each beam failure index corresponds to a BFR MAC-CE as shown in FIG. 3 and the beam failure index of the BFR MAC-CE is determined by the beam failure index of the PUSCH including the MAC-CE.

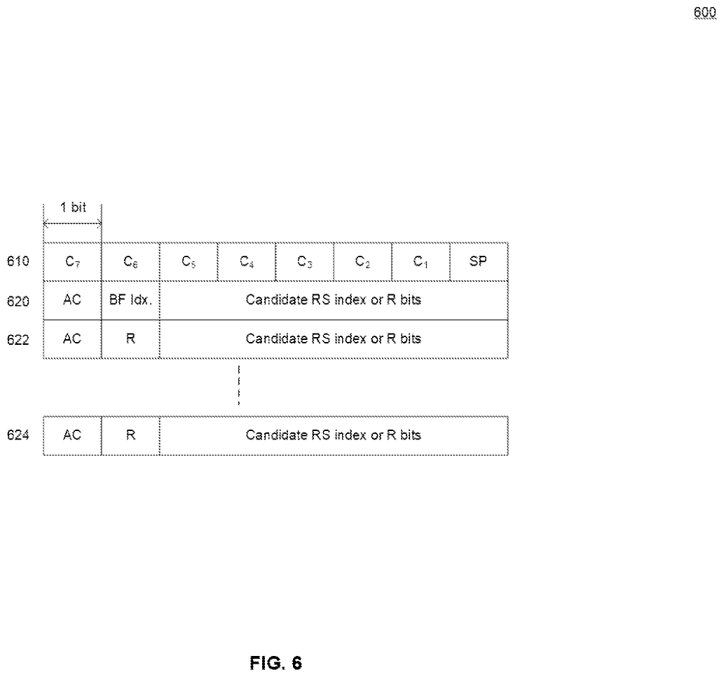

FIG. 6 illustrates a second example MAC-CE, in accordance with present implementations. As illustrated by way of example in FIG. 6, a second example MAC-CE 600 includes a serving cell group 610, a first AC field 620, a second AC field 622, and a third AC field 624.

In some implementations, the beam failure index of the BFR MAC-CE can also be determined by the beam failure index associated with PDCCH scheduling the PUSCH including the BFR MAC-CE. Alternatively, in some implementations, a beam failure index corresponding to a BFR MAC-CE is included in the BFR MAC-CE as shown in FIG. 6. The first octet including AC field includes BFI of the BFR MAC-CE. In some implementation, if only SP is set 1 and all Ci is set 0, there is a octet including the BFI. In some implementations, the bit field of the BFR index indicates the beam failure index of the BFR MAC-CE. In some implementations, the Ci indicates whether the beam failure is detected based on the candidate reference signal resource set q0 with a serving cell relative index i in a serving cell set that includes serving cells associated with the beam failure index of the BFR MAC-CE.

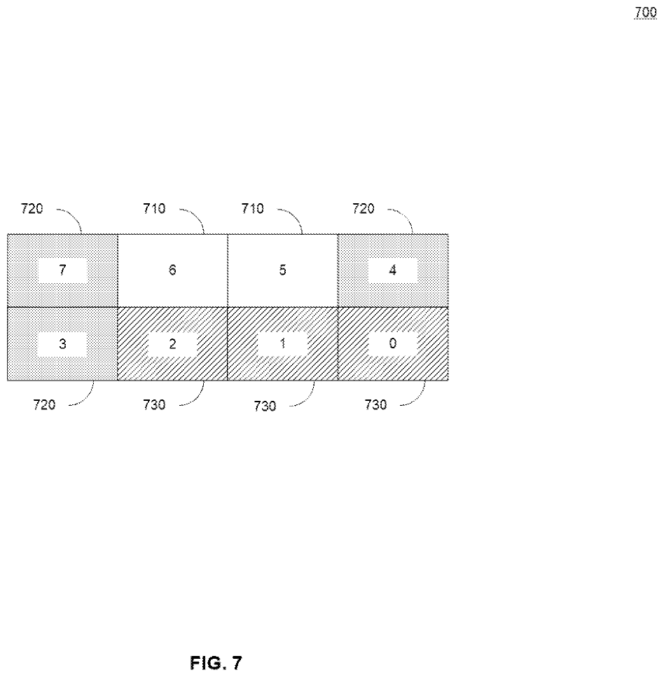

FIG. 7 illustrates a second example plurality of serving cells, in accordance with present implementations. As illustrated by way of example in FIG. 7, a second example plurality of serving cells 700 includes a first plurality of serving cells 710 without beam failure index 0 and without beam failure index 1, a second plurality of serving cells 720 with beam failure index 0 and without beam failure index 1, and a third plurality of serving cells 730 with beam failure index 0 and with beam failure index 1.

In some implementations, the serving cell relative index is a relative index among a serving cell set. In some implementations, Cᵢ corresponds to the i^{th} serving cell in a serving cell set. The serving cell set includes serving cell with the feature. The serving cell relative index in the serving cell set is got in ascending order based on the absolute serving cell index. For example, the serving cell set includes serving cell associated with a beam failure index 0. As another example, the serving cell set includes serving cell associated with a beam failure index 0 and with at least one feature according to the example features of FIG. 7. The beam failure index associated with a serving cell comprises the beam failure index configured with BFR parameter for the serving cell.

For example, the UE can be configured with 8 serving cells, and the beam failure index associated with each serving cell is configured according to the example features of FIG. 7. Then, the serving cell set corresponding to beam failure index 0 is set 0 including serving cell 0, serving cell 1, serving cell 2, serving cell 3, serving cell 4, and serving cell 7, and the serving cell set corresponding to beam failure index 1 is set 1, including serving cell 0, serving cell 1, and serving cell 2. The Cᵢ in the BFR MAC-CE with beam failure index 0 in FIG. 3 or 6 is for serving cell relative index i in serving cell set 0. The Cᵢ MAC-CE with beam failure index 1 in FIG. 3 or 6 is for serving cell relative index i in serving cell set 1. The serving cell relative index starts from 0 and SP corresponds to serving cell relative index 0, i.e i=0, 1, . . . , S−1. S is the number of serving cells in the serving cell set, i.e., the S bits corresponding to the serving cell set includes SP bit and Cᵢ bits. Alternatively, in some implementations, the serving cell set corresponds to a beam failure index excludes at least one SPCell and the S bits corresponding to the serving cell set excludes SP bit and only includes Cᵢ bits. The serving cell relative index starts from 1 and SP only corresponds to SPCell, i.e., i=1, . . . , S. The serving cell relative index i among serving cell set is a relative index and in ascending order based on the serving cell absolute index.

In another implementation, the serving cell set does not include the SPCell with serving cell absolute 0. In some implementations, the serving cell relative index starts from 1 and the SP field only corresponds to SPCell, i.e., i=1 . . . S. Then, the serving cell set corresponding to beam failure index 0 is set 0 including serving cell 1, serving cell 2, serving cell 3, serving cell 4, and serving cell 7, and the serving cell set corresponding to beam failure index 1 is set 1 including serving cell 1, and serving cell 2. In some implementations, the serving cell associated with beam failure index j includes serving cell configured with a BFR parameter with beam failure index j or includes a serving cell configured with beam failure index j.

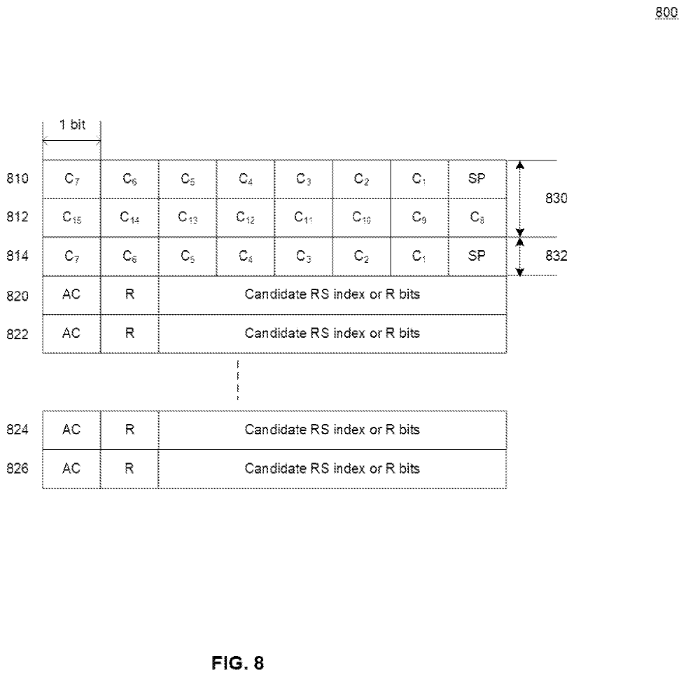

FIG. 8 illustrates a third example MAC-CE, in accordance with present implementations. As illustrated by way of example in FIG. 8, a third example MAC-CE 800 includes a first serving cell set 810 associated with a beam failure index 0 830, a second serving cell set 812 associated with the beam failure index 0 830, a third serving cell set 814 associated with a beam failure index 1 832, a first AC field 820, a second AC field 822, a third AC field 824, and a fourth AC field 826.

In some implementations, one BFR MAC-CE includes more than one bitmap field for serving cell indication. Each of the bitmap fields is associated with a respective beam failure index. The number of bits in the two bitmap field can be different as shown in FIG. 8 by way of example. The bit number of bitmap associated with beam failure index 0 is 16 bits such as 810 and 812. The bit number of a bitmap associated with beam failure index 1 is 8 bits such as 814. In some implementations, the serving cell set associated with beam failure index 0 includes more than 8 serving cells and the serving cell set associated with beam failure index 1 includes 8 or less than 8 serving cells.

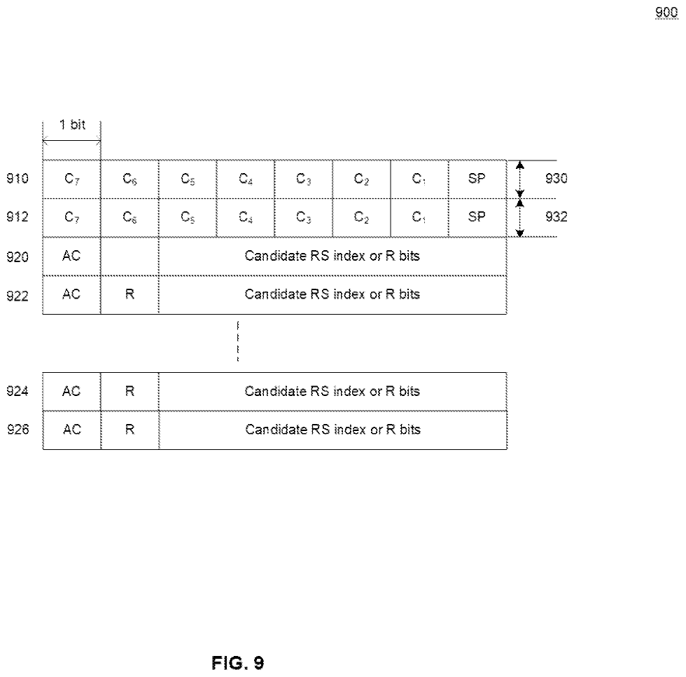

FIG. 9 illustrates a fourth example MAC-CE, in accordance with present implementations. As illustrated by way of example in FIG. 9, a fourth example MAC-CE 900 includes a first serving cell set 910 associated with a beam failure index 0 930, a second serving cell set 912 associated with a beam failure index 1 932, a first AC field 920, a second AC field 922, a third AC field 924, and a fourth AC field 926.

In another implementation, the bit number of the two bitmap fields can be the same, but the serving cell set associated with the two bitmap fields can be different as shown in FIG. 9 by way of example. The Ci associated with beam failure index j corresponds to serving cell relative index i among the serving cell set j, where j=0, 1 . . . J−1, and J is the number associated with a beam failure index. The serving cell set j includes serving cells configured with beam failure index j or configured with BFR parameter with beam failure index j. The serving cell index among a serving cell set is a relative index and in ascending order based on a serving cell absolute index. In some implementations, the serving cell set corresponding to beam failure index 0 is set 0 including serving cell 0, serving cell 1, serving cell 2, serving cell 3, serving cell 4, and serving cell 7, and the serving cell set corresponding to beam failure index 1 is set 1 including serving cell 0, serving cell 1, and serving cell 2, as shown in FIG. 7. The serving cell set can include the SPCell with serving cell absolute 0. In some implementations, the serving cell relative index starts from 0 and the serving cell set includes SPCell if the SPcell is associated with a beam failure index of the serving cell set, the SP field corresponds to a serving cell with relative index 0. Alternative, the serving cell relative index starts from 1 and the serving cell set does not include SPCell, the bits corresponding the serving cell set only includes Cᵢ and doesn't include SP bit.

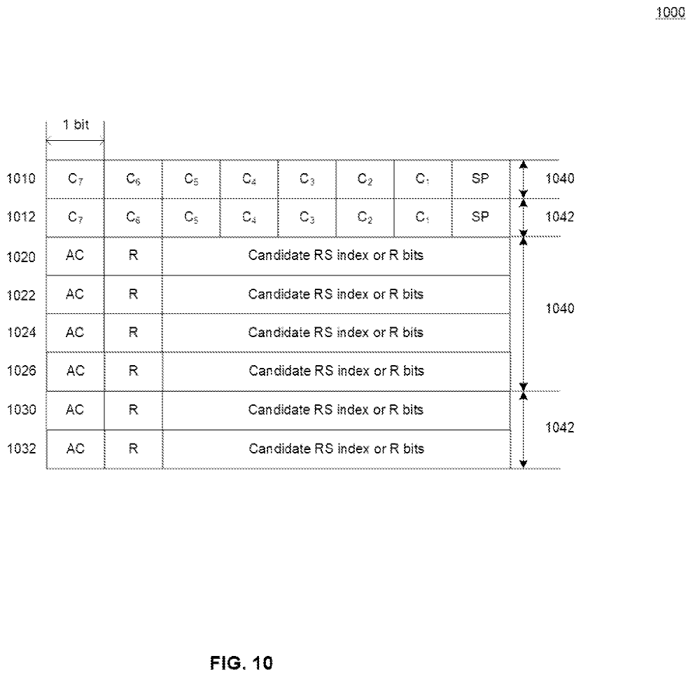

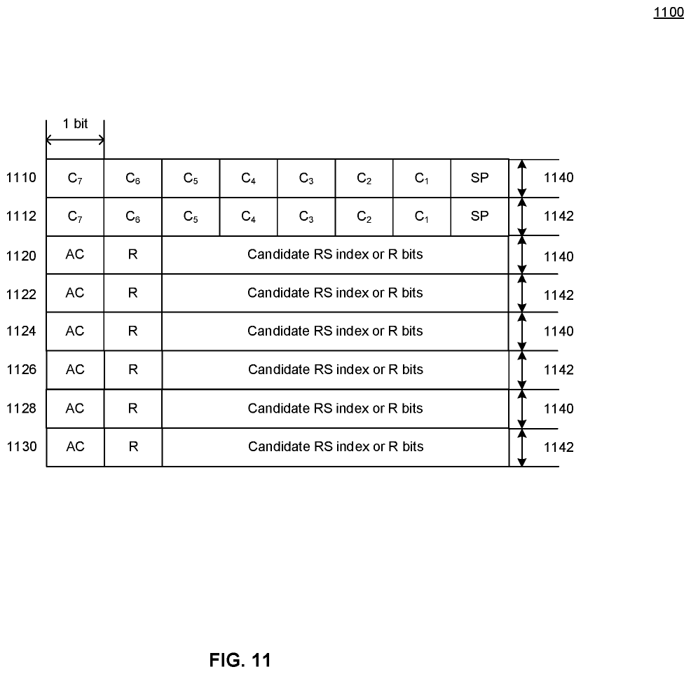

In some implementations, the UE reports beam failure information for more than one beam failure index in one BFR MAC-CE as shown by way of example in FIG. 8, FIG. 9, FIG. 10 and FIG. 11.

FIG. 10 illustrates a fifth example MAC-CE, in accordance with present implementations. As illustrated by way of example in FIG. 10, a fifth example MAC-CE 1000 includes a first serving cell set 1010 associated with a beam failure index 0 1040, a second serving cell set 1012 associated with a beam failure index 1 1042, a first AC field 1020 associated with the beam failure index 0 1040, a second AC field 1022 associated with the beam failure index 0 1040, a third AC field 1024 associated with the beam failure index 0 1040, a fourth AC field 1026 associated with the beam failure index 0 1040, a fifth AC field 1030 associated with the beam failure index 1 1042, and a sixth AC field 1032 associated with the beam failure index 1 1042. In some implementations, the octets containing an AC field are present first in ascending order based on the serving cell index associated with the same beam failure index, then in ascending order based on a beam failure index, as shown by way of example in FIG. 10.

FIG. 11 illustrates a sixth example MAC-CE, in accordance with present implementations. As illustrated by way of example in FIG. 11, a sixth example MAC-CE 1100 includes a first serving cell set 1110 associated with a beam failure index 0, 1140, a second serving cell set 1112 associated with a beam failure index 1, 1142, AC fields 1120, 1124, and 1128 associated beam failure index 0, 1140, and AC fields 1122, 1126, and 1130 associated beam failure index 1, 1142. The octets containing an AC field are present first in ascending order based on a beam failure index associated with same serving cell index, then in ascending order based on the serving cell index, as shown by way of example in FIG. 11.

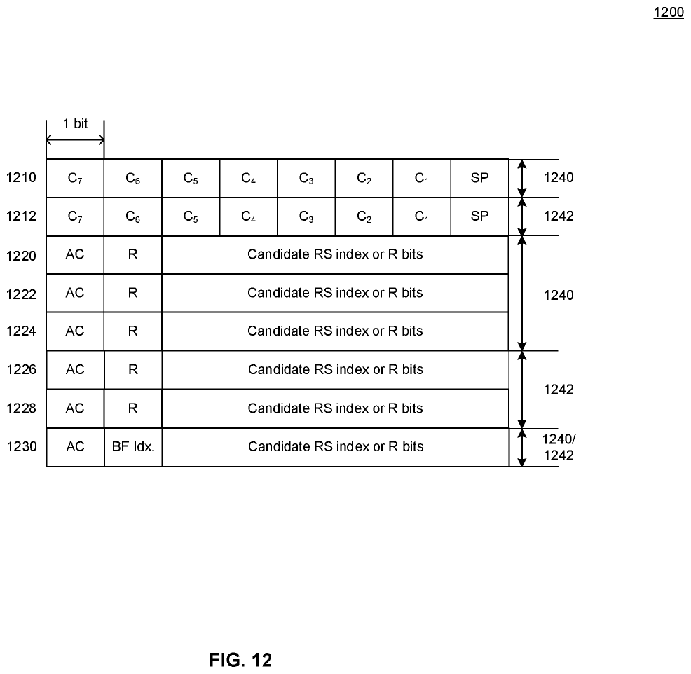

FIG. 12 illustrates a seventh example MAC-CE, in accordance with present implementations. As illustrated by way of example in FIG. 12, a seventh example MAC-CE 1200 includes a first serving cell set 1210 excluding SPCell of SP field associated with a beam failure index 0, 1240, a second serving cell set 1212 excluding SPCell of SP field associated with a beam failure index 1, 1242, the octect 1220, 1222 and 1224 including AC fields associated beam failure index 0, 1240, and corresponding to the first serving cell set 1210, the octect 1226 and 1228 including AC fields associated beam failure index 1, 1242, and corresponding to the second serving cell set 1212, the octect 1220, 1222, and 1224 including AC fields for one of the two SP bits and associated with a beam failure indicated by BF Idx. The octets containing an AC field corresponding to the first serving cell set are present first, then the octets containing an AC field corresponding to the second serving cell set, and the octets containing an AC field corresponding to SP filed at the end, as shown by way of example in FIG. 12.

In some implementations, the UE reports beam failure information using BFR MAC-CE, the SP field in the BFR MAC-CE corresponds to the SPcell as shown by way of example in FIGS. 3, 6, 8, 9, 10 and 11. If the SP field is set to 1, it indicates that beam failure is detected for SPCell and does not indicate the presence of the octet containing AC field for SPCell. The BFR MAC-CE does not include the octet containing AC field for SPCell. In another implementation, if the SP field is set to 1, it indicates that beam failure is detected and that the octet containing the AC field for SPCell is present in the BFR MAC-CE as shown in FIG. 12. In some implementations, whether the SP field set to 1 means the presence of octet containing AC field for SPCell can be configured by gNB. Alternatively, in some implementations, whether the SP field set to 1 means the presence of octet containing AC field for SPCell can be distinguished using the MAC-CE sub-header. For example, the MAC-CE sub-header is or includes logical channel identification (LCD). The UE can select the BFR MAC-CE format according to the LCID.

In another implementation, whether the SP field set to 1 means the presence of octet containing AC field for SPCell depends on the number of SP filed with 1. If only one SP field is set 1, the SP field indicates the presences of octet containing AC filed of SPCell. If two SP field are set to 1, the two SP fields indicate the presences of one octet containing the AC field for SPCell as shown in FIG. 12. The octet containing the AC field for SPCell includes a beam failure index and the octet containing AC field for other serving cell Cᵢ and does not include the beam failure index as shown in FIG. 12. In FIG. 12, the number of octets containing the AC field for SCell (Secondary cell) associated with beam failure index 0 is 3 because the bitmap Cᵢ associated with beam failure index 0 has only 3 bit with 1. In some implementations, the SCell includes a secondary serving cell with serving cell absolute index other than 0. The number of octets containing the AC field for SCell associated with beam failure index 1 is 2 because the bitmap associated with beam failure index 1 has only 2 bit filed with 1.

In some implementations, the number of octet containing AC filed for each SCell corresponding to a Cᵢ can be one or two, but the number of octet containing AC filed for SPCell corresponding to SP field only can be one. In another implementation, whether the SP field set to 1 means the presence of octet containing AC field for SPCell depends on the serving cell of an SR-BFR, or scheduling request BFR. If the SR-BFR isn't in SPCell, the two SP bits can both indicate the presence of an octet containing an AC field. One BFR MAC-CE can include more than one octets containing AC fields for SPCell associated with different beam failure index respectively. In another implementation, whether the SP field is set to 1 means the presence of octet containing AC field for SPCell depends on the serving cell of PUSCH including the BFR MAC-CE. If the PUSCH isn't in SPCell, the two SP bits can both indicate the presence of an octet containing AC field. One BFR MAC-CE can include more than one octet containing AC fields for an SPCell associated with different beam failure index respectively.

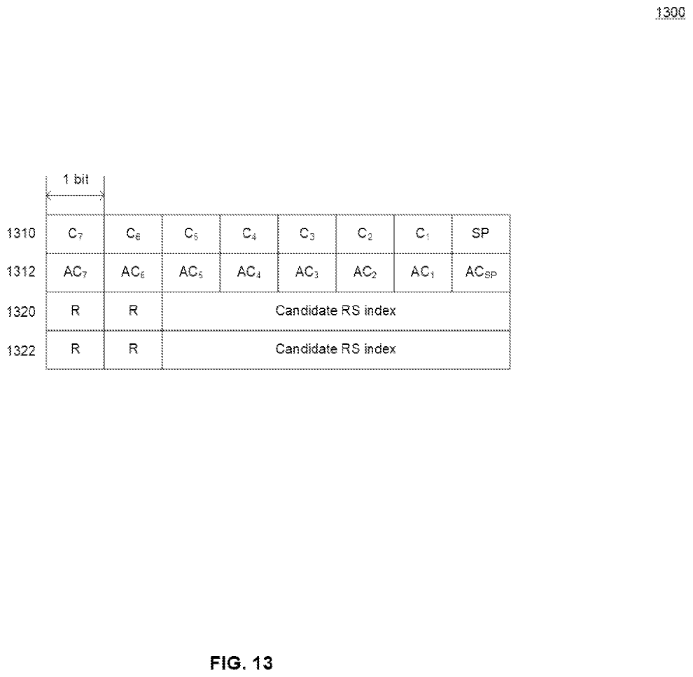

FIG. 13 illustrates an eighth example MAC-CE, in accordance with present implementations. As illustrated by way of example in FIG. 13, an eighth example MAC-CE 1300 includes a first bitmap with S bits 1310 and a second bitmap with S bits 1312, wherein S=Q, the S bits and the Q bits correspond to the same serving cell set. In some implementations, the AC field for different serving cells is in continuous bit as shown in FIG. 13, as opposed to in discrete bit as shown in FIGS. 3, 6, 8, 9 and 12. In some implementations, the octet containing candidate RS for a serving cell is present only when the AC field of the serving cell is set 1.

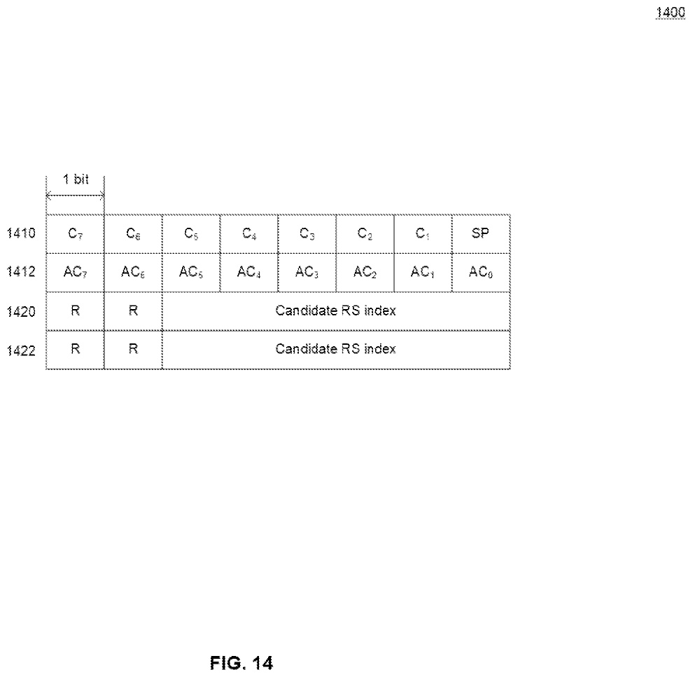

FIG. 14 illustrates a ninth example MAC-CE, in accordance with present implementations. As illustrated by way of example in FIG. 14, a ninth example MAC-CE 1400 includes a first bitmap with S bits 1410 and a second bitmap with S bits 1412, wherein S is equal to or smaller than Q depending on the number of value 1 in the S bits, the S bits and the Q bits correspond to the different serving cell set. In some implementations, the number of bits in AC bitmap field can further be determined the number of 1 in the first bitmap. The first bitmap indicates whether the beam failure is detected for each serving cell. The AC field indicates whether a new candidate resource from candidate resource set is found for a beam failure serving cell with corresponding value 1 in first bitmap. If the AC filed is set 1, octet containing candidate resource index for the beam failure is present. The number of bits in the AC bitmap is determined according to the number of 1 in the first bitmap as shown in FIG. 14 by way of example. The octet containing candidate RS index for a serving cell is present when the AC field is set 1. In some implementations, the ACi corresponds to the i^{th} beam failure serving cell whose Cj is set 1.

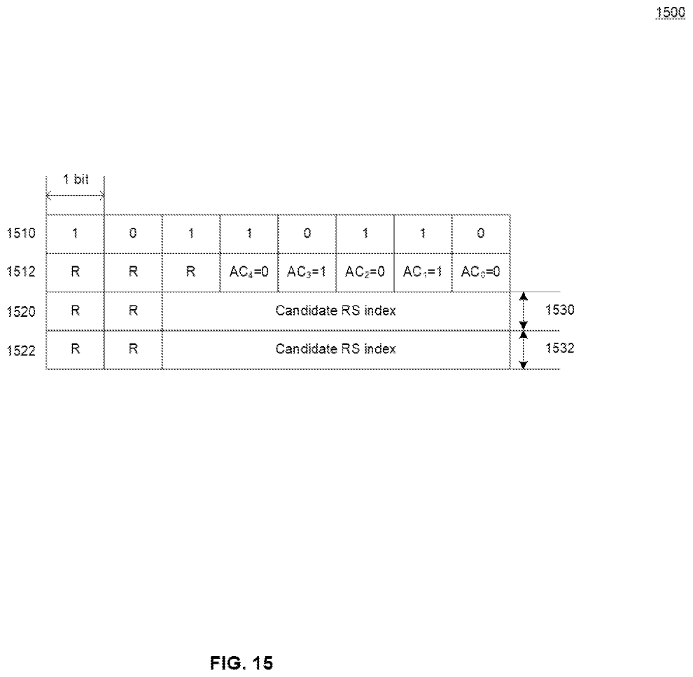

FIG. 15 illustrates an example MAC-CE format of FIG. 14.

For example, the bit value in the Cᵢ in FIG. 14 is set as shown in FIG. 15 by way of example. The AC bitmap needs 5 bits as there are 5 beam failure serving cells based on the first octet. The set including AC₀, AC₁, AC₂, AC₃, and AC₄ corresponds to beam failure serving cells C₁, C₂, C₄, C₅, and C₇ in order. Then, the octet containing candidate RS index is present when the AC field is set 1 and in ascending order, based on serving cell index as shown in FIG. 15 by way of example, 1520 corresponds to the first 1 in the first bitmap AC₁ and 1522 corresponds to the second 1 in the first bitmap AC₃. There are three fields in one BFR MAC-CE. The first field indicates whether beam failure is detected for each serving cell as 1510 or 1410. The second field indicates whether new candidate RS is found for a beam failure serving cell as 1512 or 1412. The third field indicates a new candidate RS for a AC field bit set to 1 as 1520 and 1522, or 1420 and 1422. In this example, each field of the three field contains continuous bits. The number of bits in second field is determined according to the number of bit set 1 in the first field. The number of octets in third field is determined according to the number of bit set 1 in the second field.

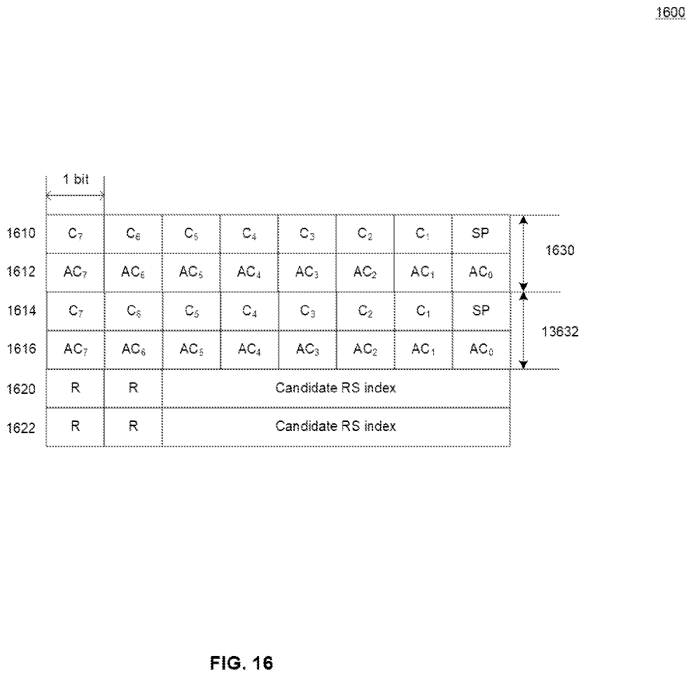

FIG. 16 illustrates an eleventh example MAC-CE, in accordance with present implementations. As illustrated by way of example in FIG. 16, an eleventh example MAC-CE 1600 includes the first bitmap 1610 and the second bitmap 1612 associated with beam failure index 0, 1630, the first bitmap 1614 and the second bitmap 1616 associated with beam failure index 0, 1632.

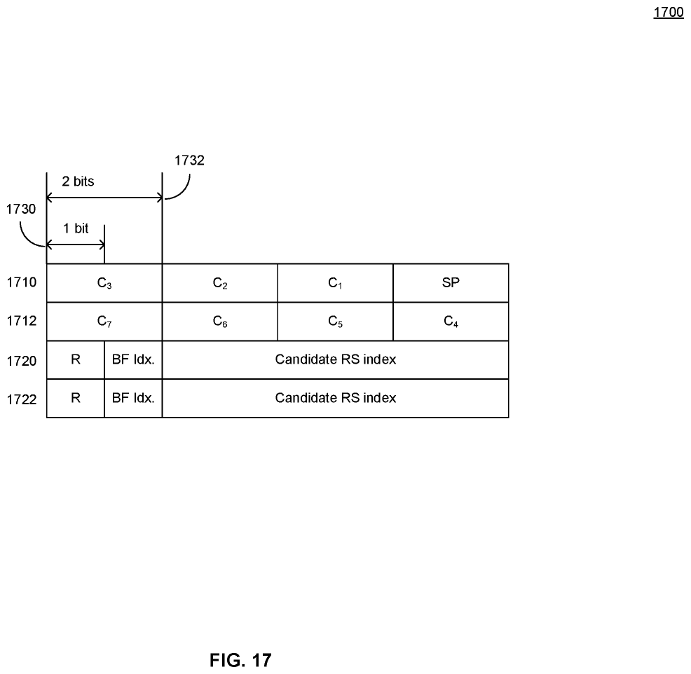

FIG. 17 illustrates a twelfth example MAC-CE, in accordance with present implementations. As illustrated by way of example in FIG. 17, a twelfth example MAC-CE 1700 includes S pairs of bits. Each pair 1732 corresponds to a serving cell. The octets 1720 and 1722 each contain a BF Indx and a candidate RS resource index.

In this example, there are two bits for each serving cell. In some implementations, the different value of the two bits indicate one of a plurality of states. In some implementations, the states include a first where beam failure is not detected for the serving cell, a second state where beam failure is detected for the serving cell but no new candidate is found for the serving cell, a third state where beam failure is detected for the serving cell and one octet containing new candidate RS is present for the serving cell, and a fourth state where beam failure is detected for the serving cell and two octets containing new candidate RS are present for the serving cell. The two bits for each serving cell can be continuous. The octet containing candidate RS index includes BFIndex to indicate from which set the candidate RS is selected.

Further example. In some implementations, the gNB configures the BFR MAC-CE format used by the UE. Alternatively, in some implementations, the UE selects BFR MAC-CE formats and reports the selection. For example, the UE reports the selection using LCID associated with the BFR MAC-CE. In some implementations, the BFR MAC-CE formats includes following at least two formats. In some implementations, the formats include a first format where one BFR MAC-CE includes beam failure information for one beam failure index. Beam failure information for different beam failure indices is reported in different BFR MAC-CE as shown in FIGS. 3, 6, 13 14 and 15. In some implementations, the formats include a second format where one BFR MAC-CE can include beam failure information for different beam failure indices as shown in FIGS. 8, 9, 10, 11, 12, 16, and 17. In some implementations, the formats include a third format where one BFR MAC-CE does not include an octet containing an AC field or a candidate RS index for SPCell. In some implementations, the formats include a fourth format where one BFR MAC-CE can include up to one octet containing AC field and/or a candidate RS index for SPCell. In some implementations, the formats include a fifth format where one BFR MAC-CE can include up to X octets containing AC field or a candidate RS index for SPCell. In some implementations, X is the number of beam field indices. Alternatively, in some implementations, X is the number of beam field indices of an SPCell. In some implementations, the formats include a sixth format where the bit field Cᵢ corresponds to a serving cell with absolute index i. In some implementations, the formats include a seventh format where the bit field Cᵢ corresponds to serving cell with relative index i among serving cells with the feature.

In some implementations, when the gNB configures the selection between a first format and a second format, the selection signaling also indicates the HARQ-ACK feedback format for different CORESET pool index. When the signaling indicates the first format, then the HARQ-ACK of different CORESET pool index is separately feedback in different HARQ-ACK codebook or different PUCCH/PUSCH. When the signaling indicates the second format, the HARQ-ACK of different CORESET pool index is jointly feedback in one HARQ-ACK codebook or one PUCCH/PUSCH.

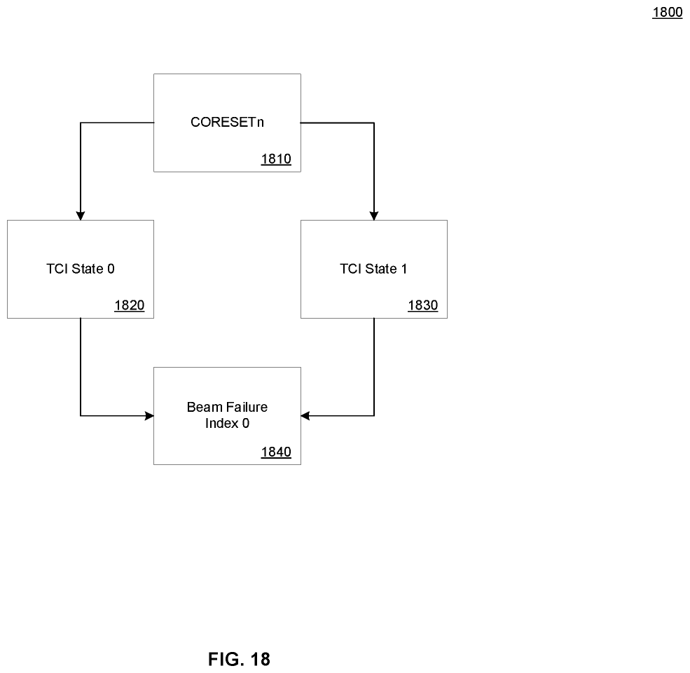

FIG. 18 illustrates a first example core resource set (CORESET) configuration, in accordance with present implementations. As illustrated by way of example in FIG. 18, a first example CORESET configuration 1800 includes CORESET 1810, TCI state 0 1820, TCI state 1 1830, and both TCI state 0 and TCI state 1 are associated with beam failure index 1840.

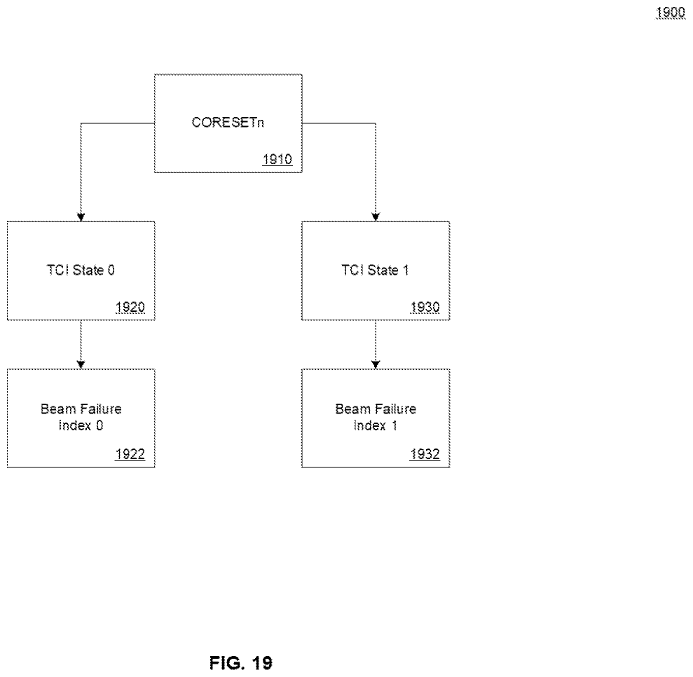

FIG. 19 illustrates a second example CORESET configuration, in accordance with present implementations. As illustrated by way of example in FIG. 19, a second example CORESET configuration 1900 includes CORESET 1910, TCI states 1920 and 1930, and beam failure indices 1922 and 1932.

In some implementations, the UE determines the beam failure index of a quasi-co-located (QCL) RS set of a CORESET. A CORESET can be configured with more than one RS sets each of which corresponds to a TCI state. The UE determines a beam failure index for each QCL RS set as shown in FIGS. 18 and 19 by way of example. One QCL RS set includes one or more QCL RS with a different QCL parameter. One QCL-RS can be configured in one TCI state. The beam failure index of a QCL-RS set of a CORESET can be got by configuration from gNB. The beam failure index of a QCL-RS set of a CORESET can also got by a rule. For example, the beam failure index of the first TCI state of a CORESET is 0 and the beam failure index of the second TCI state of a CORESET is 1 when the CORESET is associated with two TCI states. The beam failure index of a TCI state of a CORESET also can be got according to the beam failure index of the CORESET. For example, all TCI states of a CORESET are associated with same beam failure index as shown in FIG. 18.

In some implementations, the gNB can configure whether all TCI states (i.e., information element) of a CORESET is associated with the same beam failure index. If they are different, the first TCI state is associated with beam failure index0, the second TCI state is associated with beam failure index 1. In some implementations, the beam failure detecting resource set associated with beam failure index n includes RS from QCL RS set of a CORESET In some implementations, the QCL RS set is associated with the same beam failure index n, where n=0, 1 . . . , J−1, and where J is the number of beam failure index. Thus, in some implementations, the beam failure detecting resource set and the QCL RS set are associated with the same beam failure index. For example as shown in FIG. 19 by way of example, the beam failure detecting resource set associated with beam failure index 0 can include QCL-RS in TCI state 0 of CORESET n. The beam failure detecting resource set associated with beam failure index 1 can include QCL-RS in TCI state 1 of CORESET n. Similarly, the gNB can also configure or determines beam failure index (i.e parameter index) for each of one or more information elements of a channel. The information elements includes one of: TCI state, QCL-RS set, DMRS group, spatial relationship reference signal, power information, resource information which includes at least one of time-domain resource, frequence-domain resource, code-domain resource.

In some implementations, the RS resource in a beam failure detecting resource set associated with beam failure index n is QCL-ed with QCL-RS of a CORESET associated with beam failure index n. In some implementations, a RS resource in the beam failure detecting resource set is QCL-ed with QCL RS of a CORESET and the QCL-RS and the RS resource is with the same beam failure index. For example as shown in FIG. 19 by way of example, a RS resource in a beam failure detecting resource set associated with beam failure index 0 can QCL-ed with QCL-RS in TCI state 0 of CORESET n. A RS resource in a beam failure detecting resource set associated with beam failure index 1 can QCL-ed with QCL-RS in TCI state 1 of CORESET n.

In some implementations, the QCL-RS of a CORESET can be got according to a candidate RS resource reported by the UE. In some implementations, the QCL-RS and the candidate RS resource are associated with the same beam failure index. For example, the QCL-RS set associated with beam failure index n can be got according to a candidate RS resource reported by the UE and associated with beam failure index n, where n=0, 1, . . . J−1, and where J is the beam failure index. In some implementations, the gNB can informs the number of TCI state of a CORESET for BFR, a CORESET associated with a search space for BFR. The QCL-RS in each of TCI states for the CORESET BFR is got based on the candidate RS resource. Each QCL-RS set corresponding to a TCI state. Similarly, a first information element of the channel is got according to the candidate RS resource reported by the UE, wherein the first information element and the candidate RS resource are associated with the same beam failure index.

Further example. In some implementations, the gNB configures the number of QCL-RS sets for a CORESET. For example, the CORESET is a CORESET associated with a search space for BFR. The QCL-RS in the QCL-RS set of the CORESET for BFR is got according to a candidate RS resource reported by the UE. In some implementations, if the gNB does not configure the number of QCL-RS sets for a CORESET, the number is 1.

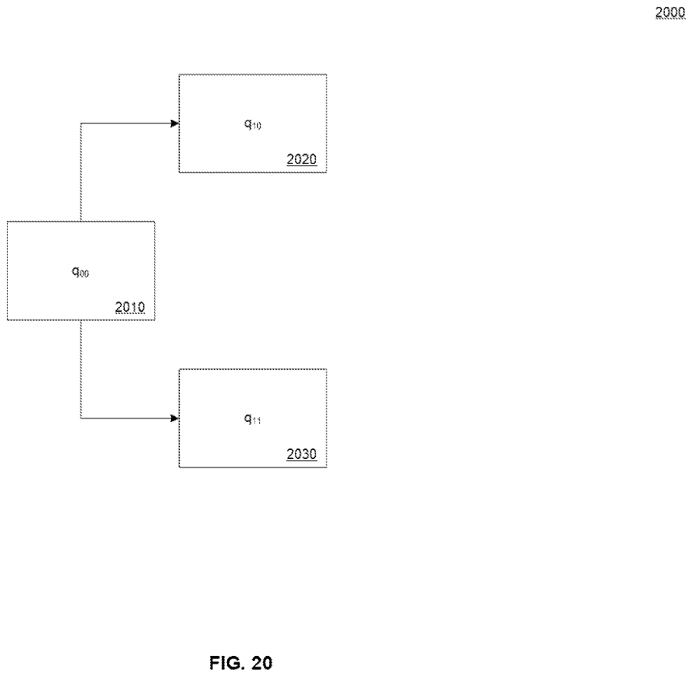

FIG. 20 illustrates a first example user equipment (UE) configuration, in accordance with present implementations. As illustrated by way of example in FIG. 20, a first example UE configuration 2000 includes a beam failure detecting reference signal resource set 2010 associated with two candidate reference signal resource sets 202 and 2030.

In some implementations, the UE is configured with one beam failure detecting signal resource set. When the UE detects beam failure occurrence based on the beam failure detecting signal resource set, the UE selects up to Y candidate RS resource from Z candidate RS resource sets. Z is equal to or larger than 1. Y equals Z or is smaller than Z. In some implementations, the UE is configured with one beam failure detecting signal resource set and two candidate RS set as shown in FIG. 20. When the UE detects beam failure based on resource set q₀₀, the UE reports 0, or 1, or 2 of candidate RS indices in a BFR MAC-CE for the beam failure. When the UE reports two candidate RS indices, the quality of each of the two candidate RSes is higher than a threshold, or that the combined quality of the two candidate RSes is higher than a threshold. The two candidate RSes are from two candidate sets, set 0 q10 and set 1 q11 respectively.

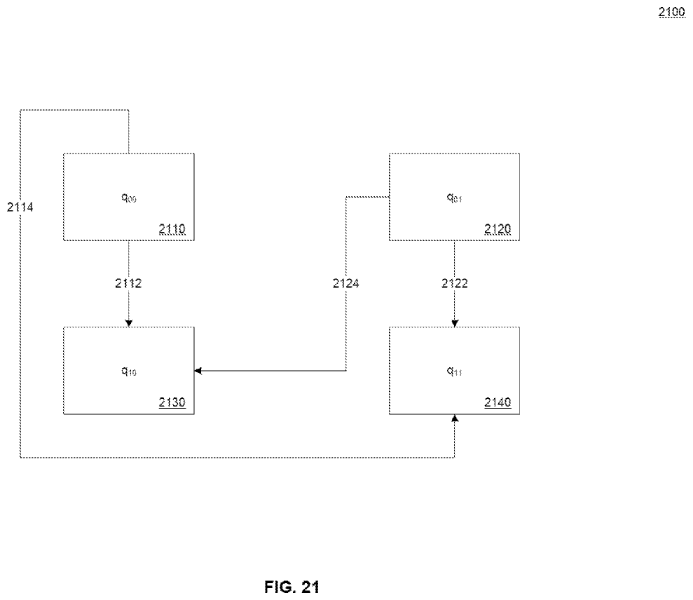

FIG. 21 illustrates a second example UE configuration, in accordance with present implementations. As illustrated by way of example in FIG. 21, a second example UE configuration 2100 includes two beam failure detecting RS set 2110, 2120, and two candidate reference signal resource sets 2130 and 2140.

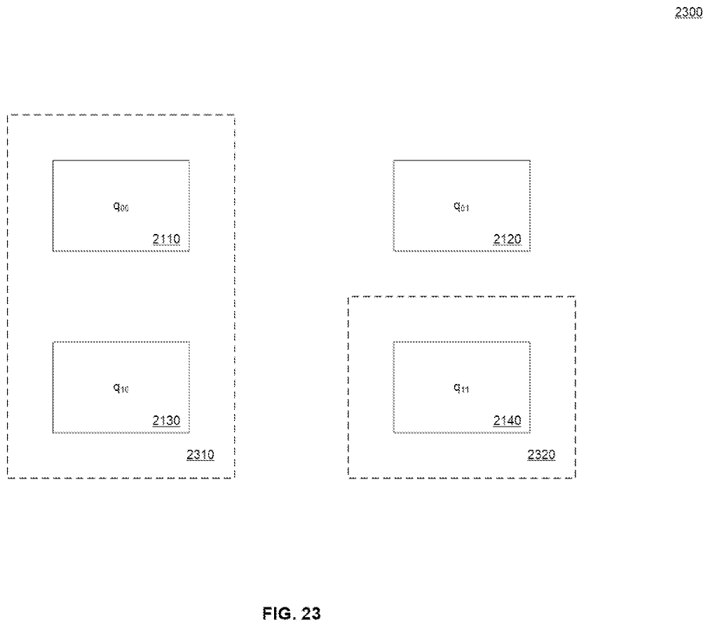

FIG. 23 illustrates a third example UE configuration, in accordance with present implementations. As illustrated by way of example in FIG. 23, a third example UE configuration 2300 includes two RS sets 2310, 2320, and one beam failure detecting RS set 2120.

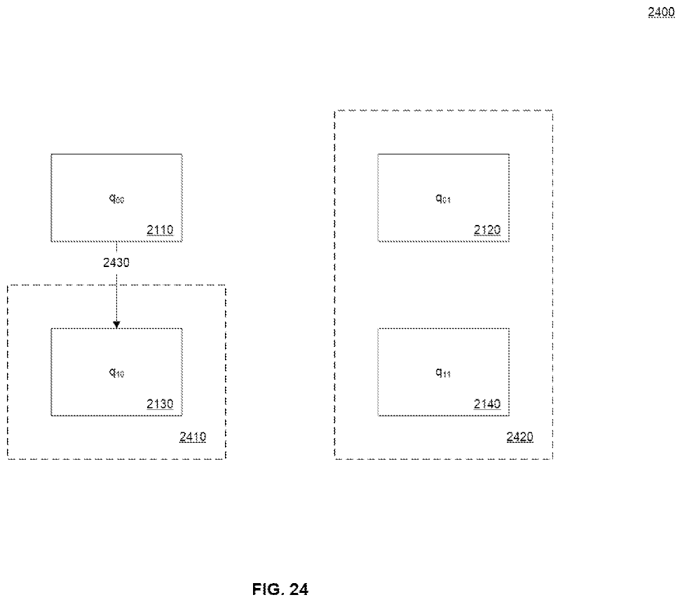

FIG. 24 illustrates a fourth example UE configuration, in accordance with present implementations. As illustrated by way of example in FIG. 24, a fourth example UE configuration 2400 includes two RS sets 2410, 2420, and one beam failure detecting RS set 2110.

In another implementation, the UE is configured with two beam failure detecting reference signal resource sets q₀₁ and q₀₀ as shown in FIG. 20,21,23,24. The UE also is configured with two candidates references signal resource set q₁₀ and q₁₁ as shown in FIGS. 20, 21, 23, and 24. In some implementations, q₀₀ and q₁₀ are associated with beam failure index 0. In some implementations, q₀₁ and q₁₁ are associated with beam failure index 1. In some implementations, the UE detects beam failure based on q₀₀ and q₀₁ respectively.

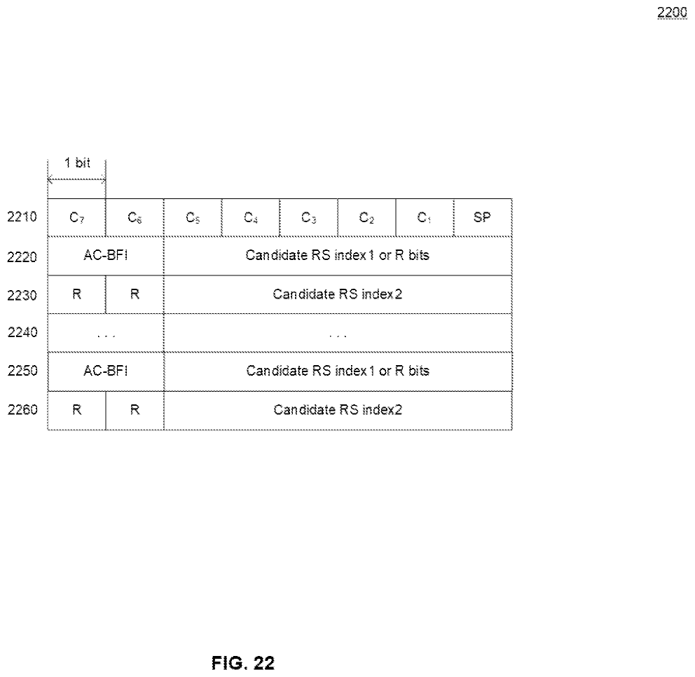

FIG. 22 illustrates a thirteenth example MAC-CE, in accordance with present implementations. As illustrated by way of example in FIG. 22, a thirteenth example MAC-CE 2200 includes serving cell 2210 AC-BFI fields 2220 and 2250, candidate RS sets 2230 and 2260, and an optional additional field 2240.

In some implementations, once the UE detects beam failure based on any one of q₀₀ and q₀₁, the UE will report up to 2 candidate RS. If the Ci is set to 1, it indicates that beam failure is detected for serving cell index i and an octet containing AC-BFI field is present. In some implementations, the serving cell index can be absolute or relative. If the Cᵢ is set to 0, it indicates that beam failure is not detected for serving cell index i and an octet containing AC-BFI field is not present. The two bit field of AC-BFI can indicates a state. In some implementations, the state includes a first state where no new candidates is found in the two RS sets. In some implementations, the state includes a second state where one new candidate is found in RS set 0. In some implementations, the state includes a third state where one new candidate is found in RS set 1. In some implementations, the state includes a fourth system state where two new candidates are found from the two RS sets respectively. In some implementations, the octet containing candidate RS index 2 for the serving cell of Cᵢ is present only when the AC-BFI for the serving cell indicates two new candidates are found. When the two candidates RSes are reported, the first octet for a serving cell containing candidates RS from RS set 0 and the second octet for the serving cell containing candidates RS from RS set 1. The RS set 0 is candidate RS set 2020 and the RS set 1 is candidate RS 2030 in FIG. 20. The RS set 0 is candidate RS set 2130 and the RS set 1 is candidate RS 2140 in FIG. 21. When the beam failure detecting RS set is q₀₁, the RS set 0 2310 includes candidate RS set 2130 and beam failure detecting RS set 2110, and the RS set 1 2320 just includes candidate RS set 2140 as shown in FIG. 23. When the beam failure detecting RS set is q₀₀, the RS set 0 2410 just includes candidate RS set 2130 and the RS set 1 2420 includes candidate RS set 2140 and beam failure detecting RS set 2120 as shown in FIG. 24.

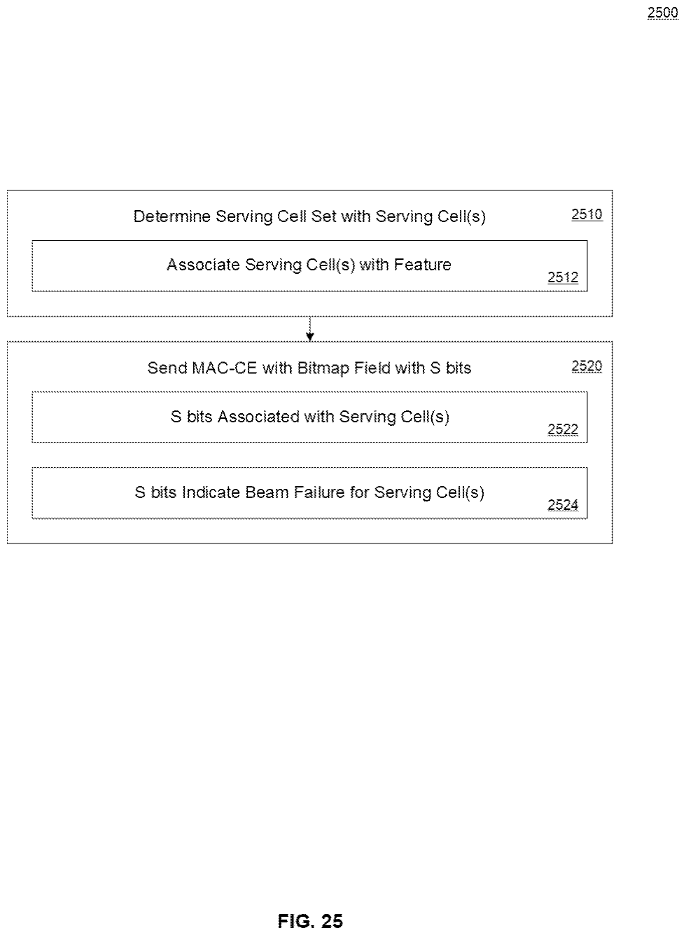

FIG. 25 illustrates a first example method for reference signaling design and configuration, in accordance with present implementations. In some implementations, at least one of the example system 100 and 200 performs method 2500 according to present implementations. In some implementations, the method 2500 begins at step 2510.

At step 2510, the example system determines a serving cell set including one or more serving cells. In some implementations, step 2510 includes step 2512. At step 2512, the example system associates at least one serving cell with a feature, or obtains an existing association between at least one serving cell and a feature. The method 2500 then continues to step 2520. At step 2520, the example system sends a MAC-CE including a bitmap field with S bits. In some implementations, step 2520 includes at least one of steps 2522 and 2524. At step 2522, the example system sends a MAC-CE with S bits each associated with a corresponding serving cell. At step 2524, the example system sends a MAC-CE with S bits indicating beam failure for at least one serving cell. In some implementations, the method 2500 ends at step 2520.

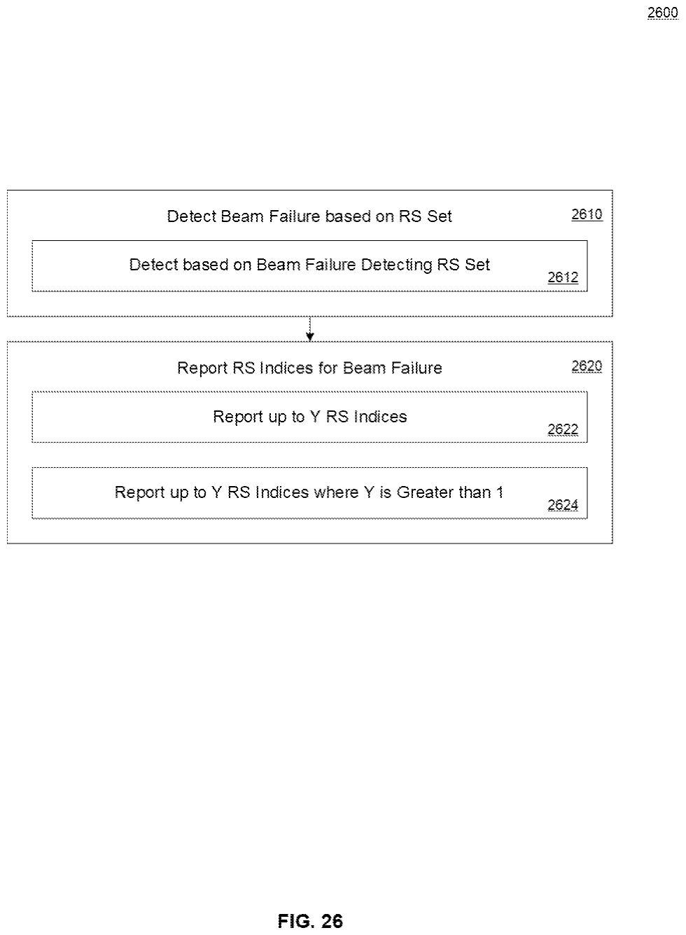

FIG. 26 illustrates a second example method for reference signaling design and configuration, in accordance with present implementations. In some implementations, at least one of the example system 100 and 200 performs method 2600 according to present implementations. In some implementations, the method 2600 begins at step 2610.

At step 2610, the example system detects beam failure based on at least one RS set. In some implementations, step 2610 includes step 2612. At step 2612, the example system detects beam failure based on at least one beam failure detecting RS set. The method 2600 then continues to step 2620. At step 2620, the example system reports one or more RS indices associated with beam failure. In some implementations, step 2620 includes at least one of steps 2622 and 2624. At step 2622, the example system reports up to Y RS indices. At step 2624, the example system reports up to Y RS indices where Y is greater than 1. In some implementations, the method 2600 ends at step 2620.

While various implementations of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one implementation can be combined with one or more features of another implementation described herein. Thus, the breadth and scope of the present disclosure should not be limited by any of the above-described illustrative implementations.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according implementations of the present solution.

Additionally, memory or other storage, as well as communication components, may be employed in implementations of the present solution. It will be appreciated that, for clarity purposes, the above description has described implementations of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method, the method performed by a wireless communication device and comprising:
sending a medium access control control element (MAC CE) signaling that includes a first bitmap field with S bits and a second bitmap field with Q bits,
wherein each of the S bits corresponds to one serving cell and indicates whether beam failure is detected for the one serving cell, and each of the Q bits corresponds to a value of 1 in the first bitmap field, wherein S is equal to 1 or an integer value greater than 1, wherein Q is an integer value equal to or less than S, and wherein the Q bits are continuous bits.

2. The wireless communication method of claim 1, wherein each of the Q bits indicates a presence of a third field containing a candidate RS index for the serving cell.

3. The wireless communication method of claim 1, wherein the MAC CE signaling includes one or more third fields, each of which corresponds to a bit with a value of 1 in the Q bits.

4. The wireless communication method of claim 3, wherein the third field includes a candidate RS index.

5. The wireless communication method of claim 1, comprising:
sending the MAC-CE signaling that includes a first field with S pairs of bits, wherein each of the S pairs corresponds to one of a plurality of serving cells.

6. The wireless communication method of claim 5, wherein each of the S pairs indicates one of following states for the one serving cell: the beam failure is detected and one candidate reference signal index is present in the MAC CE signaling, or the beam failure is detected and two candidate reference signal indices are present in the MAC CE signaling.

7. The wireless communication method of claim 1, further comprising:
determining a parameter index for an information element of a control resource set (CORESET), wherein the parameter index comprises at least one of: an index of a CORESET pool, an index of a beam failure detecting reference signal resource set, or an index of a beam failure recovery (BFR) process for a serving cell or for a bandwidth part (BWP);
reporting a candidate reference signal index; and
determining a first information element of the CORESET according to the reported candidate reference signal index,
wherein the first information element and the candidate reference signal index are associated with a same parameter index, or the first information element is associated with a parameter index corresponding to the candidate reference signal index,
wherein the information element includes a quasi-co-located-reference-signal (QCL-RS) set.

8. The wireless communication method of claim 7, further comprising:
determining a beam failure detecting RS based on the QCL-RS, wherein the beam failure detecting RS and the QCL-RS set are associated with a same parameter index, or the beam failure detecting RS is associated with a parameter index corresponding to the QCL-RS set; and
detecting beam failure based on the beam failure detecting RS.

9. A wireless communication device, comprising:
at least one processor configured to:
send, via a transmitter, a medium access control control element (MAC CE) signaling that includes a first bitmap field with S bits and a second bitmap field with Q bits,
wherein each of the S bits corresponds to one serving cell and indicates whether beam failure is detected for the one serving cell, and each of the Q bits corresponds to a value of 1 in the first bitmap field, wherein S is equal to 1 or an integer value greater than 1, wherein Q is an integer value equal to or less than S, and wherein the Q bits are continuous bits.

10. The wireless communication device of claim 9, wherein each of the Q bits indicates a presence of a third field containing a candidate RS index for the serving cell.

11. The wireless communication device of claim 9, wherein the MAC CE signaling includes one or more third fields, each of which corresponds to a bit with a value of 1 in the Q bits.

12. The wireless communication device of claim 11, wherein the third field includes a candidate RS index.

13. The wireless communication device of claim 9, wherein the at least one processor is configured to:
send, via the transmitter, the MAC-CE signaling that includes a first field with S pairs of bits, wherein each of the S pairs corresponds to one of a plurality of serving cells.

14. The wireless communication device of claim 13, wherein each of the S pairs indicates at least one of following states for the one serving cell: the beam failure is detected and one candidate reference signal index is present in the MAC CE signaling, or the beam failure is detected and two candidate reference signal indices are present in the MAC CE signaling.

15. The wireless communication device of claim 9, wherein the at least one processor is configured to:
determine a parameter index for an information element of a control resource set (CORESET), wherein the parameter index comprises at least one of: an index of a CORESET pool, an index of a beam failure detecting reference signal resource set, or an index of a beam failure recovery (BFR) process for a serving cell or for a bandwidth part (BWP);
report, via the transmitter, a candidate reference signal index; and
determine a first information element of the CORESET according to the reported candidate reference signal index,
wherein the first information element and the candidate reference signal index are associated with a same parameter index, or the first information element is associated with a parameter index corresponding to the candidate reference signal index,
wherein the information element includes a quasi-co-located-reference-signal (QCL-RS) set.

16. The wireless communication device of claim 9, wherein the at least one processor is configured to:
determine a beam failure detecting RS based on the QCL-RS, wherein the beam failure detecting RS and the QCL-RS set are associated with a same parameter index, or the beam failure detecting RS is associated with a parameter index corresponding to the QCL-RS set; and
detect beam failure based on the beam failure detecting RS.

17. A wireless communication method, the method performed by a wireless communication node and comprising:
receiving a medium access control control element (MAC CE) signaling that includes a first bitmap field with S bits and a second bitmap field with Q bits,
wherein each of the S bits corresponds to one serving cell and indicates whether beam failure is detected for the one serving cell, and each of the Q bits corresponds to a value of 1 in the first bitmap field, wherein S is equal to 1 or an integer value greater than 1, wherein Q is an integer value equal to or less than S, and wherein the Q bits are continuous bits.

18. The wireless communication method of claim 17, wherein each of the Q bits indicates a presence of a third field containing a candidate RS index for the serving cell.

19. A wireless communication node, comprising:
at least one processor configured to:
receive, via a receiver, a medium access control control element (MAC CE) signaling that includes a first bitmap field with S bits and a second bitmap field with Q bits,
wherein each of the S bits corresponds to one serving cell and indicates whether beam failure is detected for the one serving cell, and each of the Q bits corresponds to a value of 1 in the first bitmap field, wherein S is equal to 1 or an integer value greater than 1, wherein Q is an integer value equal to or less than S, and wherein the Q bits are continuous bits.

20. The wireless communication node of claim 19, wherein each of the Q bits indicates a presence of a third field containing a candidate RS index for the serving cell.
